(19) United States
(12) Patent Application Publication
(10) Pub. No.: US 2025/0307863 A1
(43) Pub. Date: Oct. 2, 2025

(54) INFORMATION PROCESSING APPARATUS, CALCULATION METHOD, AND NON-TRANSITORY COMPUTER-READABLE MEDIUM

(71) Applicant: NEC Corporation, Tokyo (JP)

(72) Inventors: Yasuhiko YOSHIDA, Tokyo (JP); Rui KONDO, Tokyo (JP); Shinnosuke NISHIMOTO, Tokyo (JP)

(73) Assignee: NEC Corporation, Tokyo (JP)

(21) Appl. No.: 19/064,830

(22) Filed: Feb. 27, 2025

(30) Foreign Application Priority Data
Mar. 28, 2024 (JP) 2024-053501

(51) Int. Cl. G06Q 30/0214; G06F 3/01; G06Q 30/0242

(52) U.S. Cl. CPC G06Q 30/0214; G06F 3/011; G06Q 30/0246

(57) ABSTRACT

An information processing apparatus, a calculation method, and a program for more appropriately calculating an advertisement rate are provided. The information processing apparatus includes a calculation unit that calculates a reward to be paid to a user on the basis of a fact that advertisement information attached to an item carried by an avatar of the user has been visually recognized by another user and a fact that there has been an operation on link information related to the item.

### INCORPORATION BY REFERENCE

This application is based upon and claims the benefit of priority from Japanese patent application No. 2024-053501, filed on Mar. 28, 2024, the disclosure of which is incorporated herein in its entirety by reference.

### TECHNICAL FIELD

The present disclosure relates to an information processing apparatus, a calculation method, and a program.

### BACKGROUND ART

Japanese Unexamined Patent Application Publication No. 2021-193542 describes displaying advertisements on an avatar and calculating an advertisement rate on the basis of a time of contact with the avatar, and the number of persons who have contacted the avatar.

### SUMMARY

There is room for improvement to more accurately measure how much a user is interested in a product or a service of an advertisement and more appropriately calculate an advertisement rate.

The present disclosure was made to solve such a problem, and an example object thereof is to provide an information processing apparatus, a calculation method, and a program for more appropriately calculating an advertisement rate.

In a first example aspect, an information processing apparatus according to the present disclosure includes:

a calculation unit that calculates a reward to be paid to a user on the basis of a fact that advertisement information attached to an item carried by an avatar of the user has been visually recognized by another user and a fact that there has been an operation on link information related to the item.

In a second example aspect, a calculation method according to the present disclosure includes:

calculating a reward to be paid to a user on the basis of a fact that advertisement information attached to an item carried by an avatar of the user has been visually recognized by another user and a fact that there has been an operation on link information related to the item.

In a third example aspect, a program according to the present disclosure causes a computer to execute

processing of calculating a reward to be paid to a user on the basis of a fact that advertisement information attached to an item carried by an avatar of the user has been visually recognized by another user and a fact that there has been an operation on link information related to the item.

According to the present disclosure, it is possible to provide an information processing apparatus, a calculation method, and a program for more appropriately calculating an advertisement rate.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of configuration of an information processing apparatus according to the present disclosure;

FIG. 2 is a block diagram illustrating an example of a flow of a calculation method according to the present disclosure;

FIG. 3 is a block diagram illustrating an example of the configuration of the information processing apparatus according to the present disclosure;

FIG. 4 is a block diagram illustrating an example of operations of the information processing apparatus according to the present disclosure; and

FIG. 5 is a block diagram illustrating an example of a hardware configuration of the information processing apparatus and the like according to the present disclosure.

### EXAMPLE EMBODIMENT

### First Example Embodiment

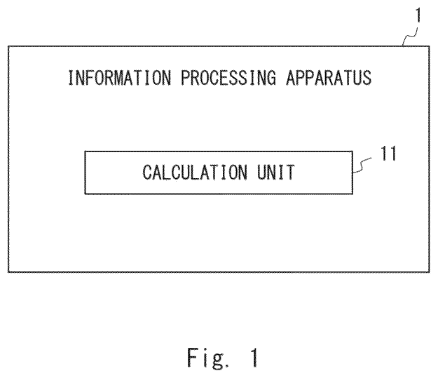

Hereinafter, a first example embodiment will be described with reference to the drawings. FIG. 1 is a block diagram illustrating a configuration of an information processing apparatus 1 according to the present disclosure. The information processing apparatus 1 may be a computer apparatus that operates when a processor executes a program stored in a memory. The information processing apparatus 1 may be, for example, a server apparatus. Furthermore, the information processing apparatus 1 may be constituted by a plurality of computer devices. In this case, components or functions constituting the information processing apparatus 1 may be distributed and arranged in a plurality of computer apparatuses. The plurality of computers may be connected via a network or may be directly connected via a cable or the like.

The information processing apparatus 1 includes a calculation unit 11. The calculation unit 11 may be software or a module, processing of which is executed by a processor executing a program stored in a memory. Alternatively, the calculation unit 11 may be hardware such as a circuitry or a chip.

The calculation unit 11 calculates a reward to be paid to a user on the basis of the fact that advertisement information attached to an item carried by an avatar of the user has been visually recognized by another user and the fact that there has been an operation on link information related to the item. In a case where the advertisement information is visually recognized, for example, the calculation unit 11 may present the link information, or change a display form of an item with the link information incorporated therein, and calculate the reward on the basis of the number of times an operation (for example, a selecting operation) has been performed on the link information. Furthermore, the calculation unit 11 may calculate the reward on the basis of, for example, the number of times the advertisement information has been visually recognized and the number of times an operation has been performed on the link information. For the calculation unit 11, it is also possible to combine the above two examples.

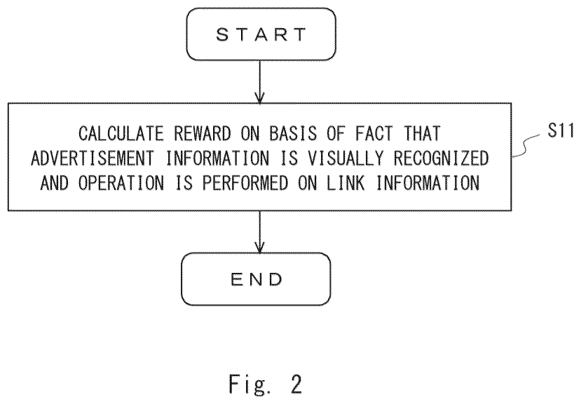

FIG. 2 is a flowchart illustrating a flow of a calculation method according to the present disclosure. First, the calculation unit 11 of the information processing apparatus 1 calculates a reward to be paid to the user on the basis of the fact that advertisement information has been visually recognized by another user and a fact that there has been an operation on link information related to the item.

It is possible to more appropriately calculate an advertisement rate by the information processing apparatus and the calculation method according to the first example embodiment.

### Second Example Embodiment

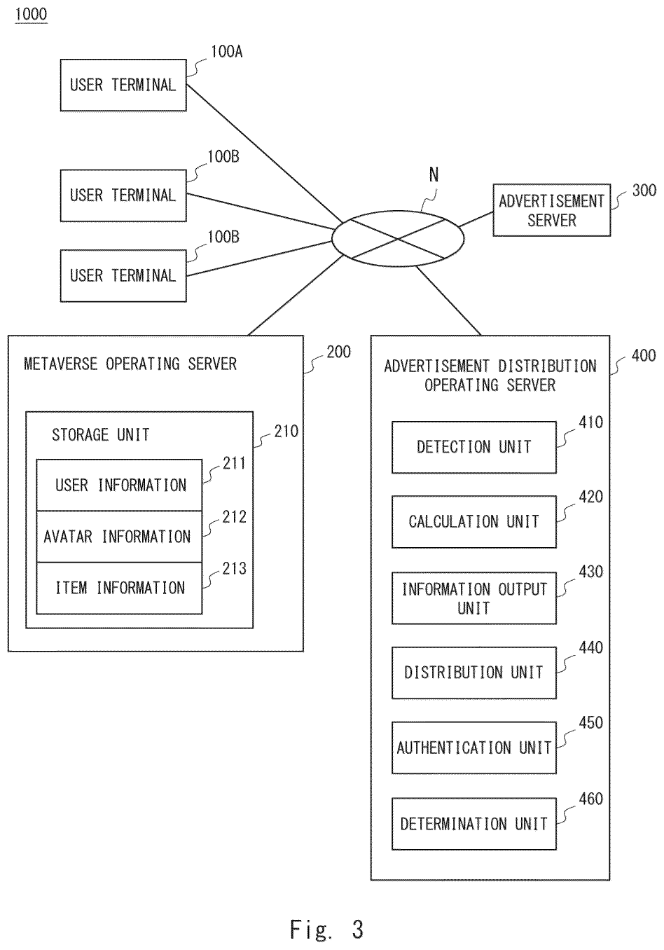

FIG. 3 is a block diagram illustrating an example of a configuration of an information processing apparatus 1000 according to the present disclosure. The information processing apparatus 1000 is a specific example of the information processing apparatus 1 described above. Alternatively, it is also possible to interpret that an advertisement distribution operating server 400, which will be described later, is a specific example of the information processing apparatus 1.

The information processing apparatus 1000 includes user terminals 100A to 100C, a metaverse operating server 200, an advertisement server 300, and an advertisement distribution operating server 400. The user terminals 100A to 100C, the metaverse operating server 200, the advertisement server 300, and the advertisement distribution operating server 400 are communicatively connected via a network N. The network N may be, for example, a communication line network such as the Internet, an intranet, a mobile phone network, or a local area network (LAN). The network N may be a wired or wireless network.

The user terminals 100A to 100C are used by users UA to UC, respectively. In a case where the user terminals 100A to 100C are not distinguished from each other, the user terminals 100A to 100C may be simply referred to as user terminals 100. In a case where the users UA to UC are not distinguished from each other, the users UA to UC may be simply referred to as users U. The user terminals 100 are, for example, head mounted displays (HMDs), personal computers (PCs), smartphones, or tablet terminals.

Each user terminal 100 includes an interface that allows a user U to input information thereto (referred to as an input interface). The input interface is, for example, a controller in a head mounted display, a touch panel in a smartphone, or a keyboard or a mouse in a personal computer. The above controller may incorporate an operation button and various sensors that detect a direction and a motion (acceleration, rotation, and the like) of the controller. The user U can cause an avatar to move, change a viewpoint, or make utterances in a metaverse by inputting information to the user terminal 100 via the input interface. In addition, the user U can select link information displayed in a window or the metaverse by inputting information to the user terminal 100.

Each user terminal 100 includes an interface that displays various kinds of information for the user U through the user terminal 100 (referred to as a display interface). The display interface may be configured of, for example, a liquid crystal display. In a case where the user terminal 100 is a head mounted display, the display interface is attached to the head of the user U and covers the field of view of both eyes of the user. The user U wearing the head mounted display can view a video displayed on the display interface. Various kinds of information such as objects in the metaverse and web pages are displayed on the display interface.

The user terminal 100 may further include a camera that images the eyes of the user U. A video captured by the camera may be used for analysis of a line-of-sight direction of the user U, analysis of pupil information of the user U, and the like. As the pupil information, it is known that the pupils of the user U are enlarged if the user U is curious about or is interested in a target, for example.

The user terminal 100 is a computer apparatus including a processor, a memory, and the like. The user terminal 100 performs various kinds of processing by the processor in the user terminal 100 executing a predetermined program.

The metaverse operating server 200 is a server that realizes the virtual space of the metaverse. The metaverse operating server 200 may be a server operating a metaverse game. The metaverse operating server 200 is a computer apparatus including a processor, a memory, and the like. The metaverse operating server 200 performs various kinds of processing by the processor in the metaverse operating server 200 executing a program.

The metaverse operating server 200 includes a storage unit 210. The storage unit 210 is a storage device that the processor of the metaverse operating server 200 can access. The storage unit 210 includes user information 211, avatar information 212, and item information 213. The user information 211 is account information of the users UA, UB, and UC who use the virtual space of the metaverse. The user information 211 may further store information of points that each user U can use in the virtual space. The user information 211 may further include information regarding the position of the avatar of the user U, a login time, and the like.

The avatar information 212 includes information regarding a 3D model of the avatar that each user U uses. The item information 213 includes information regarding a 3D model of an item (for example, a car or a T shirt) carried by the avatar. The item information 213 may include information indicating whether or not the item has been authenticated.

The metaverse operating server 200 causes the avatar of each user U to move in the metaverse space in accordance with information input to the user terminal 100. Then, the metaverse operating server 200 or the user terminal 100 generates a screen to be displayed on the user terminal 100 in accordance with the position or the like of the avatar and causes the display interface of the user terminal 100 to display the generated screen. The metaverse operating server 200 transmits the information regarding the position of the avatar or the information regarding the generated screen to the user terminal 100.

The advertisement server 300 is a server of an advertiser and manages advertisement information to be distributed. The advertisement server 300 is a computer apparatus including a processor, a memory, and the like. The advertisement server 300 performs various kinds of processing by the processor in the advertisement server 300 executing a program. The advertisement server 300 may have a function of requesting bids for advertisements via a demand-side platform (DSP) or a supply side platform (SSP). The advertisement server 300 and the advertisement distribution operating server 400 may have a function of generating the item information 213 of the item to which the advertisement information is attached.

The advertisement distribution operating server 400 may be a computer apparatus that operates by a processor executing a program stored in a memory. The advertisement distribution operating server 400 includes a detection unit 410, a calculation unit 420, an information output unit 430, a distribution unit 440, an authentication unit 450, and a determination unit 460. Each component constituting the advertisement distribution operating server 400 may be software or a module, processing of which is executed by the processor executing the program stored in the memory. Alternatively, each element constituting the advertisement distribution operating server 400 may be hardware such as a circuitry or a chip.

The detection unit 410 analyzes behaviors of avatars of other users U (for example, the user UB and UC) who are different from the user U (for example, the user UA) of the avatar owning the item with the advertisement information attached thereto. Then, the detection unit 410 detects that the advertisement information has been visually recognized by other users. Hereinafter, a case where the avatar of the user UA carries an item IA with the advertisement information attached thereto and the user UB visually recognizes the item IA will be mainly described.

The detection unit 410 may detect whether or not the advertisement information has been visually recognized by the user UB by analyzing whether or not the item IA is included in a range of a view of the user UB or whether or not the line of sight of the user UB is directed to the item IA, for example. Furthermore, the detection unit 410 may analyze whether or not the line of sight of the user UB matches the range where the advertisement information is attached.

The detection unit 410 may detect whether the advertisement information has been visually recognized by the user UB in consideration of a result of analyzing pupils of the users UB. In a case where the line of sight of the user UB matches the item IA and the pupils have been enlarged, the detection unit 410 may detect that the user UB has visually recognized the advertisement information. Furthermore, the detection unit 410 may analyze motion of the avatar of the user UB. The fact that the user UB has visually recognized the advertisement information may be detected in a case where the body or the face of the avatar of the user UB have had motion of following the user UA carrying the item IA, for example.

The calculation unit 420 is a specific example of the aforementioned calculation unit 11. In a case where the fact that the user UB has visually recognized the advertisement information is detected, for example, the calculation unit 420 presents link information, or causes a display form of the item to be changed, and calculates the reward on the basis of the number of times an operation has been performed on the link information. Alternatively, the calculation unit 420 calculates the reward on the basis of both the number of times the advertisement information has been visually recognized and the number of times the operation has been performed on the link information.

The link information is, for example, a link to a site that provides a product or a service related to the advertisement information. The calculation unit 420 may cause a window including the link information to be displayed, for example. The window may include a button for moving to the site and a button for bookmarking the site. The calculation unit 420 may transmit the link information to the user terminal 100B, for example.

The link information may be incorporated in the item IA to which the advertisement information is attached. In a case where the fact that the user UB has visually recognized the advertisement information is detected, the calculation unit 420 causes the display form of the item IA to be changed. For example, the calculation unit 420 may slightly enlarge the size of the item IA, apply a predetermined light color (for example, a fluorescent color) to the item IA, or display the contour of the item IA in an emphasized manner. Note that the calculation unit 420 may change the display form of the range in which the advertisement information is attached. In addition, the calculation unit 420 may display a mark indicating that the item IA is an item for an advertisement or may change (for example, enlarge) a display mode of the mark. The calculation unit 420 may transmit information regarding an instruction for causing the display mode of the item IA to be changed to the user terminal 100B and the metaverse operating server 200.

The calculation unit 420 calculates the reward to be paid to the user UA on the basis of at least the operation performed on the link information. The calculation unit 420 may calculates the reward on the basis of the number of users U who have moved from the link information to the destination of the link, the number of users U who have bookmarked the link information, or the number of users U who have purchased the product at the destination of the link, for example. The calculation unit 420 may calculate the reward further on the basis of the number of users U who have visually recognized the advertisement information.

The calculation unit 420 sets a weighting coefficient for calculating the reward from the number of users U who have purchased the product at the destination of the link to be larger than the weighting coefficient for calculating the reward from the number of users U who have simply moved to the destination of the link. The calculation unit 420 sets the weighting coefficient for calculating the reward from the number of users U who have moved to the destination of the link to be larger than the weighting coefficient for calculating the reward from the number of users U who have simply visually recognized the advertisement information.

The calculation unit 420 may cause the user terminal 100A to display the calculated reward. The reward may be money or may be points that can be used in the metaverse.

The information output unit 430 outputs information indicating an area or a time period in which the advertisement information has been visually recognized to the user terminal 100A. The information output unit 430 may output a graph indicating the number of times the advertisement information has been visually recognized in each area or a graph indicating the number of times the advertisement information has been visually recognized in each time period. The user UA can refer to the graph and stay in an area where it is easy to obtain a higher reward.

The distribution unit 440 distributes the item IA with the advertisement information attached thereto to the user UA. The distribution unit 440 may refer to the storage unit 210 of the metaverse operating server 200, evaluate an impression (image) that the avatar of the user UA gives, and distribute the item IA to the user UA in a case where an evaluation value is high. In a case where advertisement information for a product for women is attached to the item IA, for example, an evaluation value of an avatar representing a woman may be calculated as a high value. In a case where advertisement information for a product for children is attached to the item IA, for example, an evaluation value of an avatar representing a child may be calculated as a high value.

The authentication unit 450 determines whether or not the link information indicates a link to an inappropriate site. The authentication unit 450 may determine that the link information indicates a link to an inappropriate site in a case where the link information is registered in a predetermined list, analyze a domain of a uniform resource locator (URL), or analyze content of the site, for example. In a case where the link information indicates a link to an appropriate site, the authentication unit 450 provides an authentication mark to the item IA. The user UB can check the authentication mark and move to the destination of the link with a sense of security.

The determination unit 460 determines whether or not the user UA is a robot on the basis of an operation of the avatar of the user UA. In a case where the user UA is not a robot, the calculation unit 420 calculates the reward to be paid to the user UA. This makes it possible to prevent the reward from being given to a user who uses a robot.

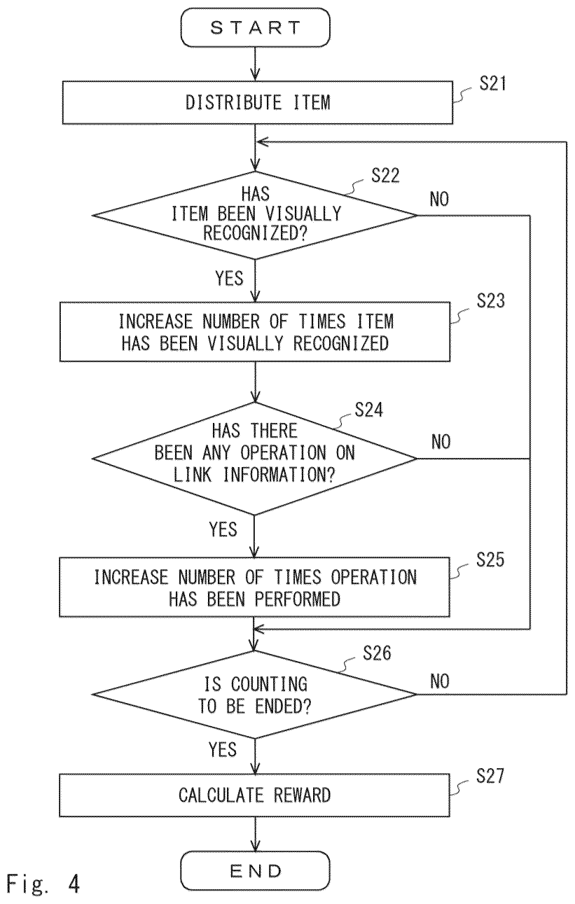

FIG. 4 is a flowchart illustrating an example of operations of the information processing apparatus 1000. First, the distribution unit 440 of the advertisement distribution operating server 400 distributes the item IA (for example, a T shirt with an advertisement of a tapioca store) with advertisement information attached thereto to the user UA (Step S21). Next, the detection unit 410 of the advertisement distribution operating server 400 determines whether the user UB or the like has visually recognized the item IA that the avatar of the user UA is wearing (Step S22). In a case where the user UB or the like has not visually recognized the item IA (NO in Step S22), Step S26 is executed. In a case where the user UB or the like has visually recognized the item IA (YES in Step S22), the advertisement distribution operating server 400 increases the number of times the item IA is visually recognized (Step S23). Note that in Step S23, the advertisement distribution operating server 400 may present the link information or change the display form of the item with the link incorporated therein. Next, advertisement distribution operating server 400 determines whether an operation has been performed on the link information (Step S24). In a case where an operation has not been performed on the link information (NO in Step S24), Step S26 is executed. In a case where an operation (for example, a selecting operation) has been performed on the link information (YES in Step S24), the advertisement distribution operating server 400 increases the number of times (referred to as the number of operations) the operation (for example, selection) has been performed on the link information (Step S25). Next, the advertisement distribution operating server 400 determines whether or not to end the counting of the number of times visual recognition has been performed and the number of times the operation has been performed (Step S26). In a case where the counting is not ended (NO in Step S26), Step S22 is executed again. In a case where the counting is ended (YES in Step S26), the calculation unit 420 of the advertisement distribution operating server 400 calculates the reward to be paid to the user UA on the basis of the number of times the visual recognition has been performed and the number of times the operation has been performed (Step S27).

According to the information processing apparatus 1000, it is possible to promote the user UA to perform an advertising activity in the metaverse space. The information processing apparatus 1000 can calculate a more appropriate advertisement rate using the link information.

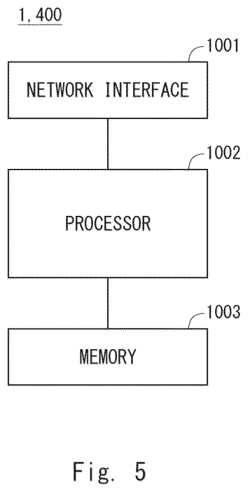

FIG. 5 is a block diagram illustrating an example of hardware configurations of the information processing apparatus 1 and the advertisement distribution operating server 400 (hereinafter, referred to as an information processing apparatus 1 and the like). Referring to FIG. 5, the information processing apparatus 1 and the like include a network interface 1001, a processor 1002, and a memory 1003. The network interface 1001 is used to communicate with other network node apparatuses that constitutes a communication system. The network interface 1001 may be used to perform wireless communication. For example, the network interface 1001 may be used to perform wireless LAN communication specified in IEEE 802.11 series or mobile communication specified in the 3rd Generation Partnership Project (3GPP; registered trademark). Alternatively, the network interface 1001 may include, for example, a network interface card (NIC) complying with IEEE 802.3 series.

The processor 1002 reads and executes software (computer program) from the memory 1003 to perform the processing in Step S11 in FIGS. 2 and S21 to S27 in FIG. 4. The processor 1002 may be, for example, a microprocessor, an MPU, or a CPU. The processor 1002 may include a plurality of processors.

The memory 1003 is constituted by a combination of a volatile memory and a nonvolatile memory. The memory 1003 may include a storage disposed away from the processor 1002. In this case, the processor 1002 may access the memory 1003 via an input/output (I/O) interface, which is not illustrated.

In the example in FIG. 5, the memory 1003 is used to store a group of software modules. The processor 1002 can perform the processing in Steps S11 and S21 to S27 by reading and executing the group of software modules from the memory 1003.

As described using FIG. 5, each of the processors included in the information processing apparatus 1 and the like in the aforementioned example embodiment executes one or more programs including a group of commands for causing a computer to perform the algorithms described using the drawings.

In the aforementioned example, the program includes a group of commands (or software codes) for causing a computer to execute one or more functions described in the example embodiment in a case where the program is read by the computer. The program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage apparatus. The program may be transmitted through a transitory computer readable medium or a communication medium. By way of example, and not limitation, transitory computer readable or communication media include electrical, optical, acoustic, or other forms of propagated signals.

Note that the technical ideas of the present disclosure are not limited to the above example embodiment and can be appropriately modified without departing from the gist.

Although the present disclosure has been described hitherto with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each drawing is merely illustrative for describing one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing illustrative example embodiments are not necessarily mandatory, and some features or steps may be omitted. The order of the steps described in any drawing may be changed as appropriate.

Although some or all of the above-described example embodiments may be described as in the following Supplements, the present disclosure is not limited to the following Supplements.

Some or all of the elements (such as configurations and functions, for example) described in Supplementary Notes 2 to 8 depending from Supplementary Note 1 may depend from Supplementary Notes 9 to 10 as well with depending relationships similar to those of Supplementary Notes 2 to 8. Some or all of the elements described in any supplementary notes may be applied to various kinds of hardware, software, recording means for recording software, systems, and methods.

### (Supplementary Note 1)

An information processing apparatus including a calculation unit that calculates a reward to be paid to a user on the basis of a fact that advertisement information attached to an item carried by an avatar of the user has been visually recognized by another user and a fact that there has been an operation on link information related to the item.

### (Supplementary Note 2)

The information processing apparatus according to Supplementary Note 1, in which in a case where the advertisement information has been visually recognized by the another user, the calculation unit presents the link information or changes a display form of an item with the link information incorporated therein.

### (Supplementary Note 3)

The information processing apparatus according to Supplementary Note 1 or 2, in which

the calculation unit calculates the reward on the basis of the number of times the advertisement information has been visually recognized and the number of times an operation has been performed on the link information, and

a weighting coefficient to calculate the reward from the number of times the advertisement information has been visually recognized is smaller than a weighting coefficient to calculate the reward from the number of times an operation has been performed on the link information.

### (Supplementary Note 4)

The information processing apparatus according to Supplementary Note 1 or 2, further including a detection unit that analyzes a behavior of an avatar of the another user or of the another user and detects that the advertisement information has been visually recognized by the another user.

### (Supplementary Note 5)

The information processing apparatus according to Supplementary Note 1 or 2, further including an information presenting unit that presents, to the user, information indicating an area or a time period in which the advertisement information has been visually recognized.

### (Supplementary Note 6)

The information processing apparatus according to Supplementary Note 1 or 2, further including a distribution unit that evaluates an impression that the avatar of the user gives to the another user and distributes the item to the user in a case where an evaluation value is high.

### (Supplementary Note 7)

The information processing apparatus according to Supplementary Note 1 or 2, further including an authentication unit that determines whether or not the link information is a link to an inappropriate site and provides an authentication mark to the item in a case where the link information is not a link to an inappropriate site.

### (Supplementary Note 8)

The information processing apparatus according to Supplementary Note 1 or 2, further including a determination unit that determines whether or not the user is a robot on the basis of a motion of the avatar,

in which the calculation unit calculates the reward in a case where the user is not the robot.

### (Supplementary Note 9)

A calculation method including calculating a reward to be paid to a user on the basis of a fact that advertisement information attached to an item carried by an avatar of the user has been visually recognized by another user and a fact that there has been an operation on link information related to the item.

### (Supplementary Note 10)

A program that causes a computer to execute processing of calculating a reward to be paid to a user on the basis of a fact that advertisement information attached to an item carried by an avatar of the user has been visually recognized by another user and a fact that there has been an operation on link information related to the item.

What is claimed is:

1. An information processing apparatus comprising:
at least one memory storing instructions and
at least one processor configured to execute the instructions to;
calculate a reward to be paid to a user on the basis of a fact that advertisement information attached to an item carried by an avatar of the user has been visually recognized by another user and a fact that there has been an operation on link information related to the item.

2. The information processing apparatus according to claim 1, wherein the at least one processor is further configured to execute the instructions to:
in a case where the advertisement information has been visually recognized by the another user, present the link information or change a display form of an item with the link information incorporated therein.

3. The information processing apparatus according to claim 1, wherein the at least one processor is further configured to execute the instructions to:
calculate the reward on the basis of the number of times the advertisement information has been visually recognized and the number of times an operation has been performed on the link information, and
a weighting coefficient to calculate the reward from the number of times the advertisement information has been visually recognized is smaller than a weighting coefficient to calculate the reward from the number of times an operation has been performed on the link information.

4. The information processing apparatus according to claim 1, wherein the at least one processor is further configured to execute the instructions to:
analyze a behavior of an avatar of the another user or of the another user and detect that the advertisement information has been visually recognized by the another user.

5. The information processing apparatus according to claim 1, wherein the at least one processor is further configured to execute the instructions to:
present, to the user, information indicating an area or a time period in which the advertisement information has been visually recognized.

6. The information processing apparatus according to claim 1, wherein the at least one processor is further configured to execute the instructions to:
evaluate an impression that the avatar of the user gives to the another user and distribute the item to the user in a case where an evaluation value is high.

7. The information processing apparatus according to claim 1, wherein the at least one processor is further configured to execute the instructions to:
determine whether or not the link information is a link to an inappropriate site and provide an authentication mark to the item in a case where the link information is not the link to the inappropriate site.

8. The information processing apparatus according to claim 1, wherein the at least one processor is further configured to execute the instructions to:
determine whether or not the user is a robot on the basis of a motion of the avatar, and
calculate the reward in a case where the user is not the robot.

9. A calculation method comprising calculating a reward to be paid to a user on the basis of a fact that advertisement information attached to an item carried by an avatar of the user has been visually recognized by another user and a fact that there has been an operation on link information related to the item.

10. A non-transitory computer-readable medium storing a program that causes a computer to execute processing of calculating a reward to be paid to a user on the basis of a fact that advertisement information attached to an item carried by an avatar of the user has been visually recognized by another user and a fact that there has been an operation on link information related to the item.
